(19) United States
(12) Patent Application Publication
(10) Pub. No.: US 2014/0195341 A1
(43) Pub. Date: Jul. 10, 2014

(54) Advertising Subsidized Computer Network Printing Systems, Methods and Products

(71) Applicant: The Printer Project, LLC, Shaker Heights, OH (US)

(72) Inventors: Ryan Clark, Cleveland, OH (US); Lance Osborne, Highland Heights, OH (US); Todd Goldstein, Shaker Heights, OH (US); Nathan Lambert, Cleveland Heights, OH (US); Ganesh Iyer, Twinsburg, OH (US)

(73) Assignee: The Printer Project, LLC, Shaker Heights, OH (US)

(21) Appl. No.: 14/202,507

(22) Filed: Mar. 10, 2014

Related U.S. Application Data
(63) Continuation-in-part of application No. 12/964,835, filed on Dec. 10, 2010, now Pat. No. 8,711,404.

(51) Int. Cl. G06Q 30/02; G06F 3/12

(52) U.S. Cl. CPC G06Q 30/0251; G06F 3/1288
USPC 705/14.49

(57) ABSTRACT

Methods, systems and non-transitory computer-readable media comprising executable instructions are provided to present one or more digital advertisements before a document is physically printed. A print request is captured and a digital advertising client selects and presents one or more digital advertisements before the print request is directed to a printer for printing. A digital advertisement may be presented using a monitor operatively connected to the client computer or a display device proximate to the printer to which the print request is directed. One or more advertisements may be incorporated within the physically printed document. The digital advertising client may be implemented on a combination of any or all of the client computer, networked servers and cloud computing servers.

### RELATED APPLICATIONS

This continuation-in-part claims priority to U.S. application Ser. No. 12/964,835, filed on Dec. 10, 2010, which claims priority to U.S. Provisional Application 61/285,251, filed on Dec. 10, 2009, each of which is incorporated by reference as if fully rewritten herein.

### FIELD OF THE INVENTION

This invention relates generally to advertising-subsidized computer network printing systems, methods and products.

### BACKGROUND

Various forms of networked printing services have been implemented to allow numerous persons the ability to print documents, for example, in higher education institutions and public libraries. Implementations of printing services, and particularly the cost and revenue models for such services, has undergone significant changes over the past several decades, from models where institutions provided free or subsidized printing to models where printing costs have been shifted in whole or in part to users.

Initially, providers of networked printing services often subsidized the cost of printing, particularly in academic and similar settings. Over time, however, that model has shifted in many instances to a cost recovery model. By 2005, many public and private educational institutions and the like had begun charging users of their printing services to recoup some or all of the printing costs, including the cost of equipment leases, paper, toner, and service contracts. In some cases, institutions make a profit, depending on factors including the volume of printing and the costs charged to users. Cost recovery models have since evolved so that, by 2010, many institutions were implementing hybrid models of cost recovery for printing, such as a predefined amount of free prints (usually between 50 and 500 impressions) with charges after the predefined threshold has been reached.

In the higher education market, public printing is further complicated by the fact that printing facilities often are implemented in a decentralized manner. Within a university, for example, there may be many departments that host—and consequently subsidize—printing for users within a department. The same may also be true for computer labs within a school or department, various student affairs organizations, and libraries, with each potentially being responsible for its own policies, printer contracts, and pricing. This makes it difficult to implement a one-size-fits-all printing policy model for an entire university.

The same is often true for public libraries. One notably difference, however, is that public libraries for the most part did not subsidize printing the way higher education did in the 1990s. Instead, many public libraries implemented cost recovery models early on. Today those cost recovery models are still in place for the most part, with public libraries sometimes subsidizing a portion of free or discounted printing for patrons, often in the range of ten free impressions per day.

In universities, libraries, and other public or semi-public settings, a large number of users often share a small number of networked printers. When a user prints to a specific networked printer or a bank of printers, it is useful to identify the user's document when it is printed. While several methods of doing this exist, including printers that wait for a user to enter a code to retrieve his document, and printers that deliver documents to a mailbox or carousel, the most common method of identifying printed documents is to print a cover page preceding the document. The cover page may be a different color of paper, different size, or have other distinguishing characteristics that make it easy to identify the beginning of a printed document in a stack of many printed documents. Such cover pages often include data printed on them such as the computer name of the user who printed it, technical numbers that track the print job, the printer name to which it was sent by servers, and other data.

Typically, in such printing environments the cost of printing each page of paper varies greatly. Minimum base costs can be estimated as between ¼ to ½ cent per page for letter-sized paper and ½ to 2 cents per page for depletion of printer consumables such as toner, imaging drum life, and printer useful life. The identifying cover sheet, in which most of the paper area is blank space, represents another cost often incurred by providers of networked printing services. In large printing environments, the printing of cover pages can add up to thousands or even tens of thousands of dollars of printing costs per year. And, that is just a fraction of the overall costs of the entire printing volume, whether subsidized by the institution or reimbursed by the individual users. A need therefore exists for a system for inserting advertisements into physically printed documents to offset or subsidize such costs and generate additional revenue.

Similar opportunities exist to insert advertisements into receipts printed in connection with point-of-sale transactions, such as the checkout systems used by public libraries. Presently, point-of-sale advertisements often are generated using paper stock having pre-printed advertisements or using a dedicated printer to print advertisements separately from the receipt, both of which have drawbacks. For example, using a separate, dedicated printer requires maintaining an adequate supply of consumables, providing for additional maintenance and support, and may reconfiguring the point-of-sale area to accommodate the additional equipment. Using paper stock with pre-printed advertisements does not permit targeting advertisements to specific customers. Users of point-of-sale systems, including public libraries, therefore could benefit from a computer network printing system that could leverage existing systems to incorporate advertisements on receipts.

Presenting digital advertisements to users of computer network printing systems, alone or in connection with printed advertisements, is another opportunity to offset or subsidize printing costs and generate additional revenue. The cost of presenting a digital advertisement often is a fraction of the cost of a printed advertisement. That is, at least in part, because a digital advertisements avoid costs associated with printer consumables such as paper stock toner, imaging drum life, printer useful life, and the like. Those costs can be avoided or minimized, and additional revenue generated, by presenting digital advertisements on the screen of a computer used to initiate a print request or a separate screen. For example, a user could be required to view and optionally interact with a digital advertisement on the client computer used to send a document to be printed on a networked printer. A user similarly could be required to view and optionally interact with a digital advertisement at a different location, such as a display device located in proximity to the networked printer to which a print request has been directed. Digital advertising also could be used in connection with printed advertisements inserted into a print request, for example, as described herein.

Consequently, any method, system, medium or mechanism that can subsidize the printing costs for individual users, generate revenue and reduce the overall printing costs to providers of networked printing services would be welcome and beneficial to such providers and their users.

### BRIEF SUMMARY OF THE INVENTION

Computer network printing systems provide an opportunity to subsidize the individual users, and/or reduce the overall printing costs to an institution through the use of paid promotional advertisements within the physically printed document, either by using the blank space on printer cover pages, or through insertion of useful document fragments on a target basis to the user, printer, room, user group, or other easily targetable criteria. Printer cover pages provide a primary opportunity to target printed advertisements to a user.

Another opportunity exists with the use of extended length paper stock in 8½ by 14 inch paper is provided having an 8½ by 11 inch upper portion integrally formed with a 8½ by 3 inch lower portion, integrally connected an separated by a foldable, tearable perforation laterally across the demarcation. Advertisements may occupy all previously blank space on the cover page; or the cover page may be divided into smaller sections and used to display multiple advertisements; or advertisements can be organized and positioned solely within the lower portion of the paper stock (with the user's requested printout maintained within the 8½ by 11 inch upper portion). Advertisements also can be inserted into documents such as receipts, including those printed on roll or continuous feed printers, at the point of sale.

Yet another opportunity exists to present digital advertising on the screen of a computer used to initiate a print request or a separate screen, such as one located in proximity to a printer. A user could be required to view and optionally interact with a digital advertisement on the client computer used to send a document to be printed on a networked printer or at a different location, such as a display device located in proximity to the networked printer to which a print request has been directed. Digital advertising also could be presented in connection with printed advertisements inserted onto cover pages, extended-length paper stock, and point-of-sale receipts.

Through these mechanisms, the sale of advertisements, as well as the ability to target and track them and thereby increasing their value, provides an opportunity to offset the institutional cost of printing cover pages and potentially provide a significant revenue stream for the institution and other providers of networked printing services.

A method and system is disclosed for using software to make use of blank space in printer cover pages or removable, or the space on perforated coupon segments of each page, by inserting additional document fragments and graphics from other sources onto these pages in either a segmented or non-segmented page format, or space on printed receipts. A system and method also is disclosed for using software to present to users, and optionally require users to interact with, digital advertisements, which are comprised of document fragments, when printing. The document fragments, including graphics, text, or both, primarily are designed for the display of advertisements. However, the system may also be used to insert university, institution or company announcements, a calendar of events, or other useful information. The software provides a method of tracking and counting the insertion of many different document fragments and targeting the printing of each document fragment based on a predefined rubric.

While a preferred embodiment is intended for use at public self-service printing locations, such as those used in higher education as well as public libraries and the like, a person having ordinary skill in the relevant art, in light of the present teachings, would find it obvious to extend these teachings to be generally applied in any public service location as well as private service locations.

It is anticipated that an embodiment may be implemented via co-location of printer drivers and servers interconnected via the Internet. Also commonly referred to as the “cloud” in cloud computing, the use of such methods provides the means through which all the necessary elements—from computing power to computing infrastructure, applications, business processes to personal collaboration—can be delivered to the individual user as a service wherever and whenever it is needed. In general the cloud—similar to its namesake of the cumulus type—is fluid and can easily expand and contract. This elasticity means that as the number of customers increase, then additional resources can increase on demand. And, just as easily, those resources can be released when they are no longer needed without having to step foot on the printer installation site.

This elasticity is one of the main reasons individual, businesses, and information technology (IT) users are moving to the cloud. In the traditional data center it has always been possible to add and release resources. However, this process couldn't be done in an automated or self-service manner. With the implementation of this type of infrastructure, the easy scalability of print solutions can be accomplished across thousands of institutions while maintaining the print management software and hardware in one central management environment.

This software tools necessary to create a complete and comprehensive printer management, advertising campaign and invoicing solution may be understood as comprising two separate modules: administrative and print management. The administrative module can be understood as comprising three logically-distinct interfaces, although other configurations are possible. The first module manages advertising campaigns and allows each advertiser to negotiate terms of their campaign with information such as start and end date for the campaign, advertisement images to run and cost per impression. This will also allow for there to be a limit on periodic expenditures for the campaign as well as a final limit to stop the campaign based on the advertisement run rate. The contact management module is intended to operate similar to a contact relationship manager (CRM) solution, and could maintain information necessary for the sale of advertisements such as, for example, contact address, phone, email, as well as follow up alert definitions and information about when campaigns are coming to a close. The invoicing interface could take information from the campaign and contact management interfaces and generate an electronic report necessary for billing the advertisers. This will allow for both a printed invoice as well as an electronic invoice that can be sent by electronic mail to the advertiser. This invoice interface may also have an internal reporting mechanism that, for example, could estimate profit margin/loss and run other reports necessary to forecasting revenue for each location. This interface can also have the ability to systematically export this data in an extensible markup language (XML) or other suitable format for incorporation into a larger interface for broader reporting. The invoicing interface also could have the ability to handle multiple billing situations. For instance, if a site chooses to be invoiced once per year, it could accommodate that as well as if site chooses to be billed once per month or at some other interval.

In its most basic sense, the print management module can be understood as substantially a remote-implemented print server. This print management module captures the print request from a client computer and compiles the printed image in a remote location to fit the needs of the institution that provides the printing service such as, for example, a library, a school or a public printing location. This module may also have the ability to manage all image files that are used in the production of the final print advertisement delivered to the user. It is anticipated that this architecture will be fast and scalable in order to manage hundreds of thousands of images used in a campaign. There may also exist a template management interface that allows for the configuration of different templates that may be requested and negotiated by the installation site during the sales process or at a later time. Finally, a print queue software may be used to handle multiple printer configurations. Any one site may have one or many printers installed, and this print queue software is anticipated as being capable of managing print jobs for all the possible locations. In each instance, the printer job may be received, processed, assigned a template, inserted into the template along with document fragments, and sent to the printer for final production.

Advertisements may be sold for the various regions of each individual print job. These print jobs can use one or more templates that dictate the layout for the final production in order to print at the appropriate size and location. Large full page advertisements may also be an option as a cover letter for each print job. This template will utilize advertisements that are specifically managed in the campaign management software and with content stored in the image management interface.

The second template could be similar in layout to the first template however with a major difference. This template would give consideration to the content being displayed in the content area section and have the ability to match up advertisements based on keywords found in the content. This template could integrate directly with the advertisement management interface, or also could be used in situations where third party advertisement services are used, such as, for example, Hey Butler®, Groupon®, Ebates® or ValueClick®, just to name a few advertisement service providers. Such templates or third party providers can also be installed and configured at each individual installation site.

This advertisement template can further have the ability to display multiple advertisements, such as many as ten side bar advertisements, or as few as none. If there are no banner advertisements, the template could utilize the space on the page for more content to be displayed on the page. The same is true for the side bar advertisements. Templates also can be used to insert advertisements and other content onto receipts printed using point-of-sale computers.

Another embodiment enables the presentation of digital advertisements to users of computer network printing systems. A digital advertising system may be implemented in a manner similar to a system used to insert printed advertisements, but instead of (or in addition to) inserting advertisements into the printed document, for example on the cover page or on extended-stock paper, the digital advertisements may be presented to a user on the client computer used to send the print request to the networked printer or at a separate location, such as on a screen located in proximity to the networked printer. Interaction with a digital advertisement also may be required before a print request is printed. Just as with the insertion of printed advertisements, the software can provide a method of tracking and counting the insertion of many different types of advertisements, along with additional data, such as data generated as a result of a user's interaction with digital advertisements.

As know to those skilled in the art, using information from a database, such as age, gender, classes taken, etc., to better target a specific advertisement to a defined demographic increases the value of each impression of that advertisement. Advertisements that contain serialized coupons or other tracking information used to redeem offers allow an advertiser to better refine the rubric used to target advertisements using closed loop feedback and develop user profiles. Data from interaction with digital advertisements also could be collected and used to develop user profiles that could be used to target advertisements.

### BRIEF DESCRIPTION OF THE DRAWINGS

FIG. 1 illustrates an exemplary embodiment of a computer network printing system for automatically generating and inserting printed content.

FIG. 2a illustrates an alternate exemplary embodiment of a computer network printing system in which documents may immediately be sent from a print server.

FIG. 2b illustrates a variant of FIG. 2a in which an embodiment may also act as a printing device.

FIG. 3a illustrates an alternate exemplary embodiment of a computer network printing system that includes functions as a print server.

FIG. 3b illustrates an alternate exemplary embodiment of a computer network printing system that functions as a print queue (i.e., performs all printing jobs necessary of a print server).

FIG. 4 illustrates an exemplary layout of the internal configuration of a computer network printing system.

FIG. 5a illustrates an exemplary embodiment of a printer cover page and the blank space that may be on it.

FIG. 5b illustrates an exemplary embodiment of a printer cover page showing the free space subdivided into geometric regions that may have advertisements inserted.

FIG. 6a through FIG. 6f illustrate alternate exemplary embodiments of automatically generated printed advertising content inserted into individual printer content pages.

FIG. 7 illustrates an exemplary embodiment of a computer network printing system capable of inserting advertisements in receipts printed at the conclusion of a point-of-sale transaction.

FIG. 8 illustrates an exemplary embodiment of a computer network printing system that includes a digital advertising client for displaying digital advertisements.

FIG. 8a illustrates an alternate exemplary embodiment of a computer network printing system that includes a digital advertising client for displaying digital advertisements.

FIG. 9 illustrates an exemplary embodiment of a digital advertising client for displaying digital advertisements that is implemented on a client computer and a networked server.

FIG. 9a illustrates an exemplary embodiment of a digital advertising client for displaying advertisements that is implemented on a client computer, a cloud computing service and a local area network server.

FIG. 10 illustrates an exemplary embodiment of a digital advertising client that presents digital advertisements on a display other than the client computer used to initiate a print request.

### DETAILED DESCRIPTION OF THE INVENTION

Reference will now be made in detail to exemplary embodiments of a computer network printing system, examples of which are illustrated in the accompanying figures. Other embodiments may be utilized and structural and functional changes may be made without departing from the respective scope of the invention. Moreover, features of the various embodiments may be combined or altered without departing from the scope of the invention. As such, the following description is presented by way of illustration only and should not be understood to limit in any way the various alternatives and modifications that may be made to the illustrated and described embodiments and still be within the spirit and scope of the invention.

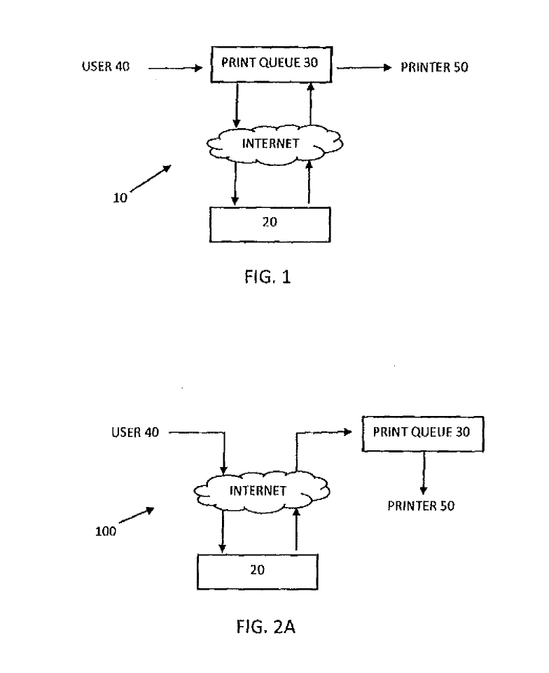

FIG. 1 shows an exemplary embodiment of a computer network printing system, generally noted as 10, in which a user-requested print document is processed, or modified, by a remote implemented print server 20. A print management module captures the print request 30 from a client computer 40 and compiles the printed image in a remote location to fit the needs of the institution that provides the printing service such as, for example, a library, a school or a public printing location. The print management module residing on server 20 modifies a printed document 50 while that document is in a computer print queue 30. The remote implemented print server 20 may access printing queue 30 of an existing server to modify a printing cover page or insert a cover page that did not exist, or to modify the print content and insert advertising content that did not previously exist to a portion of the page. In another embodiment, the digital advertisements can be presented to a user before the print request is printed.

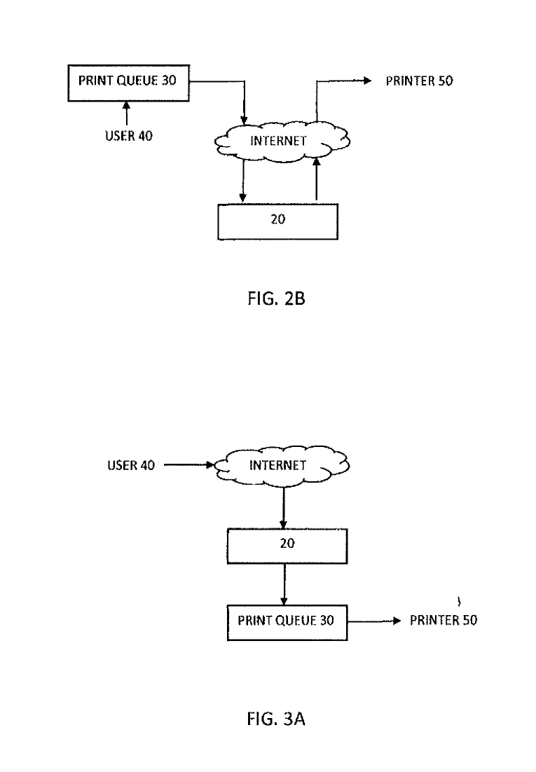

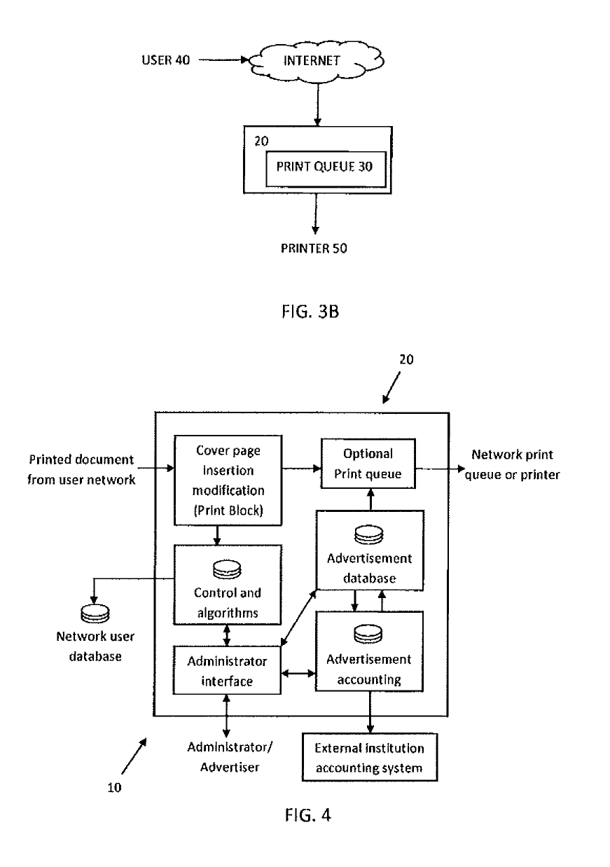

The computer network printing system may be configured to act as a printing device, as shown in FIG. 2a and generally noted as 100. In this variation, the remote implemented print server 20 may receive the user print request 40 directly, and immediately resend the documents to the local print queue 30. Further, the remote implemented print server 20 may also act as a printing device to a print queue 30, as shown in FIG. 2b and thereby modify a printing cover page or insert a cover page that did not exist after the document leaves the computer print queue 30.

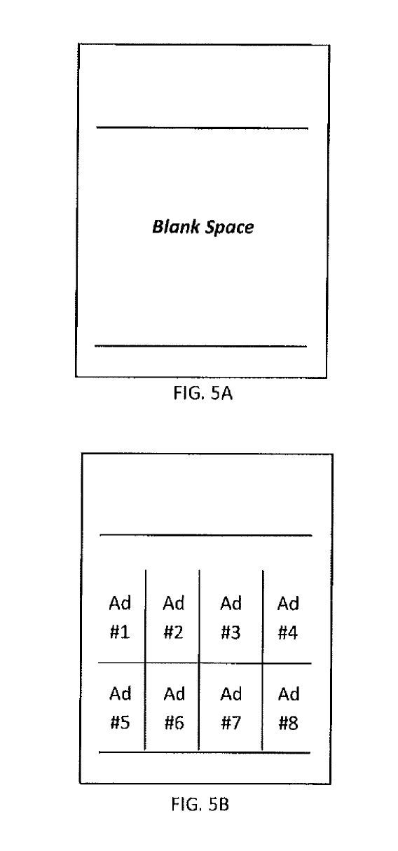

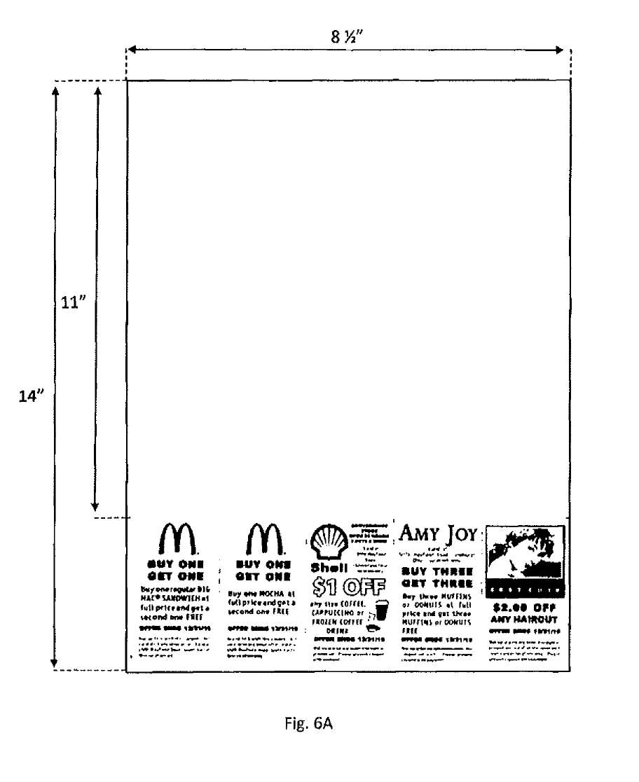

As shown in FIG. 3a, server 20 may act directly as a print server to a user 40, with the content modified, as described in greater detail below, and directed to the local print queue 30. Unlike the variant shown in FIG. 2a, the user 40 of FIG. 3a prints directly to the server 20. Similarly, as shown in FIG. 3b, the remote implemented print server 20 also may contain a print queue 30 such that it performs all or substantially all of the printing jobs necessary of a print server.

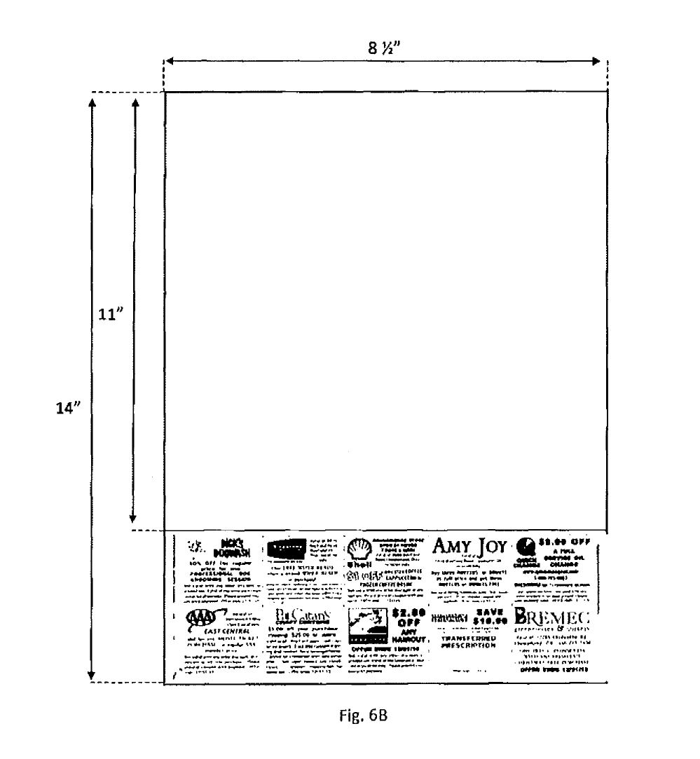

FIG. 4 illustrates as a block layout the internal configuration of the computer network printing system 10 in which an assembly of software, databases, and interfaces to one or more printing queue and network printer is provided. In one embodiment, the computer network printing system may access an institution's database to retrieve user-specific information, such as demographic information. The computer network printing system may exist in an existing computer server or be enclosed in a separate hardware device that interfaces to an existing network, printers, databases, and other resources.

Exemplary embodiments of the computer network printing system may operate in a number of different ways. For example, it may access the printing queue of an existing server and modify a printing cover page, or insert a cover page that did not exist, or generated printed advertising content onto printer cover pages or onto individual printer content pages, as shown in FIG. 1. It also may intercept printing job documents either entering the printing queue, as shown in FIG. 2a, or leaving the printing queue, as shown in FIG. 2b, to modify a printing cover page, or insert a cover page that did not exist, or generated printed advertising content onto printer cover pages or onto individual printer content pages. Further, as shown in FIG. 3a, the computer network printing system may act as the user print server and insert a cover page or advertising content on individual printer content pages before sending the document to a downstream printing queue, or directly to printer hardware, as shown in FIG. 3b. In each of these methods of operation, data contained in the print job may be used to access databases and determine which advertisements or other document fragments to insert into the printer cover page or individual content page. An appropriate advertiser account can then be debited for the insertion of each advertisement.

According to one embodiment of the computer network printing systems disclosed herein, advertisers can have access in real time or delayed time to account information as well as the option to refine placement and digital advertising presentation rubrics based on feedback relating to the effectiveness of advertisement placement and presentation. As shown, for example, in FIG. 4, an embodiment can include tools to bill an advertiser and provide detailed information about the advertisements printed or presented. These tools provide import and export capabilities as well as links to other accounting systems and databases.

A computer network printing system may make use of a link to an institution's database of current users as well as detailed information the institution has about these users (such as gender, age, field of study, department, etc.). Such information may be accessed directly from an institution's database or from information stored in a database within the computer network printing system. Additional information also may be collected based on use of a computer network printing system, including information disclosed by a user through interacting with digital advertisements. This additional user information allows an advertiser to use a rubric to target a user more specifically. For example, an advertiser may only want to advertise to users who are female, between 21 and 25 years of age, and an undergraduate. The embodiment links to the institution's databases or other data stores, including a data store within the computer network printing system that may include data collected from a user's interaction with digital advertisements, using a common standardized method know to those skilled in the art. This method may be, but is not limited to, Lightweight Directory Access Protocol (LDAP), or Structured Query Language (SQL) and its variants.

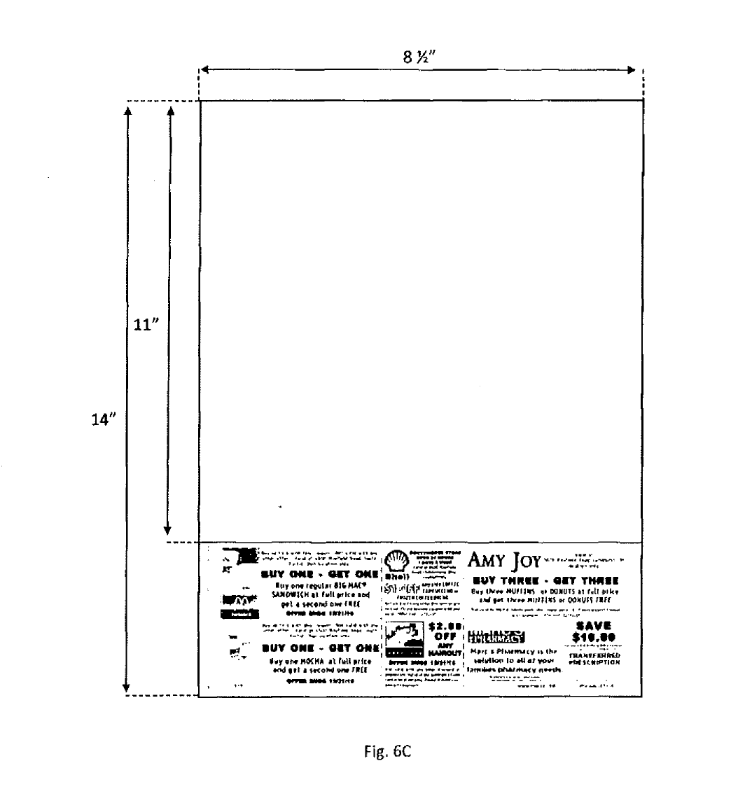

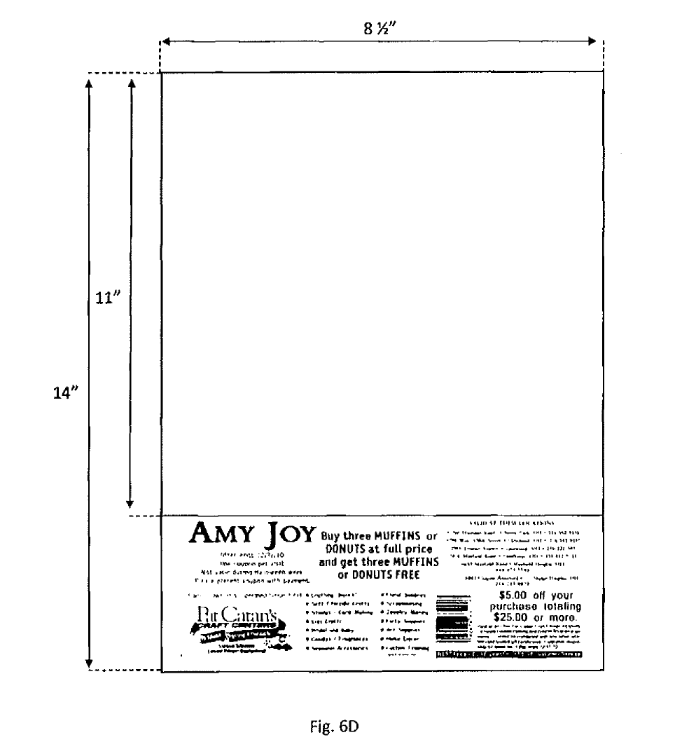

Embodiments of the computer network printing systems described herein may contain one or more algorithms to choose advertisements to insert into a cover page or onto printer content pages or to be presented digitally based on many factors. Such algorithms may be configured for a variety of objectives, such as to maximize profit to the institution, mix announcements with advertisements, or, for example, insert the institution's calendar of events on the first page a user prints each day. Cover pages may be divided into a number of geometric printing regions (as shown in FIG. 5b, for example) in any configuration that then can be used to charge advertisers based on advertisement size, as can regions on individual printer content pages, and advertisements may occupy one or more adjacent geometric printing region. Digital advertisements similarly can be presented in varying formats and configurations, with advertisers being charged according to the use of such formats and configurations. Advertisers also may be charged according to various forms and degrees of interaction with digital advertisements.

In one embodiment, a computer network printing system is implemented using software, databases, and an interconnection to an existing computer network are embedded on a microcomputer system in a dedicated hardware device. It may, however, also share an existing hardware device with other software and applications. In one embodiment, the computer network printing system acts as a printing document pass-through with an optional print queue allowing it to sit in any of the network locations detailed in FIG. 1 through FIG. 3. It will be obvious to a person having ordinary skill in the relevant art embodiments of computer network printing systems of the type described herein may interface to networked user databases and institution billing systems using standardized networks and protocols. A computer network printing system also may contain an administrator/advertiser interface as a web page or specialized software application.

An embodiment of the computer network printing system contains a database of advertisements, a database of advertiser accounting data, an administrator interface, and a control block and database in addition to the printing block and optional print queue, as shown in conjunction with FIG. 4. In operation, when a print job enters the print block:
(1) the print user is extracted and sent to the control block;
(2) the control block retrieves useful information from the network user database;
(3) it control block uses information retrieved from the institution database and rubrics stored in the control block to choose advertisements stored in the advertisement database;
(4) the advertisements are sent to the print block;
(5) the advertisement insertion is logged, and the advertiser is debited in the advertiser accounting database; and
(6) the print block inserts the advertisement(s) and sends the document to the optional print queue or to the network.

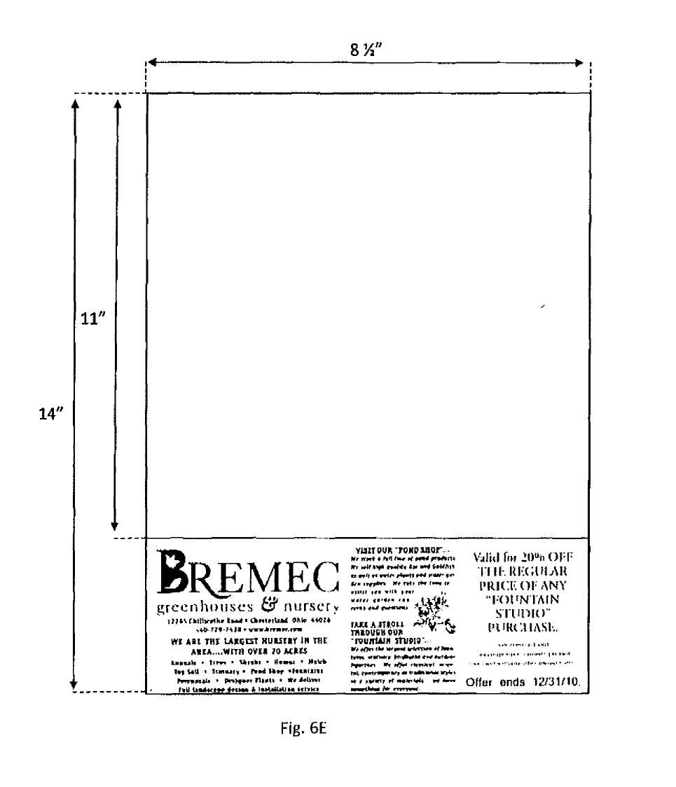

Exemplary purposes of the computer network printing system include subsidizing the individual users and reducing the overall printing costs to an institution through the use of paid promotional advertisements within the physically printed document, either by using the blank space on printer cover pages, or through insertion of useful document fragments on a target basis to the user, printer, room, user group, or other easily targetable criteria. A necessary element for such systems is a physical printed document in which an advertisement or promotional coupon can be created. While the number, types and methods of generating a physical printed advertisement should not be limited, for purposes of enabling a preferred embodiment at the time of this disclosure it is anticipated that a printer cover page, as shown in conjunction with FIG. 5a-5b, provides a primary opportunity to target printed advertisements to a user. A alternate embodiment exists with the use of extended length paper stock, as shown in conjunction with FIG. 6a-6f, in which 8½ inch by 14 inch paper is provided having an 8½ inch by 11 inch upper portion integrally formed with a 8½ inch by 3 inch lower portion, integrally connected an separated by a foldable, tearable perforation laterally across the demarcation. Advertisements may occupy all previously blank space on the cover page; or the cover page may be divided into smaller sections and used to display multiple advertisements; or advertisements can be organized and positioned solely within the lower portion of the paper stock (with the user's requested printout maintained within the 8½ inch by 11 inch upper portion).

Through these mechanisms, the sale of advertisements, as well as the ability to target and track them thereby increasing their value, provides an opportunity to offset the institutional printing costs and potentially provides a significant revenue stream for the institution. Print advertisements may be sold for the various regions of each individual print job, and digital advertisements may be sold to be displayed before printing each individual print job. These print jobs can use one or more templates that dictate the layout for the final production print. For example, in the template layout shown in FIGS. 6a through 6f show salable regions to be located on a portion of each content page of a print layout for advertisers to purchase. Large full page advertisements will also be an option as a cover letter for each print job. Typically, print output requested in an 8½ inch by 11 inch format. The use of extended length paper stock in 8½ inch by 14 inch paper can thereby provided an 8½ by 11 inch upper portion integrally formed with a 8½ inch by 3 inch lower portion. The creation of a perforated connection can thereby form a separate foldable, tearable perforation laterally across the demarcation to allow newly printed coupon or advertisement to be removed without adverse effect on the print content itself.

The creation of the advertising content itself can be done in a number of ways. As should be apparent to a person having ordinary skill in the relevant art, in light of the present teachings, the use of pre-printed advertisement content can applied onto the integrally formed 8½ inch by 3 inch lower portion, thereby merely providing a blank 8½ inch by 3 inch content area ready for print requests. This would allow the creation of a perforated connection can thereby form a separate foldable, tearable printed coupon or advertisement to be removed without adverse effect on the print content itself. However, such a method would lack the ability to allow for the use creating targeted, specific, real-time generated adverting content. To allow for these later features, it is anticipated that particular templates would be used that have the ability to have as many as ten side bar advertisements and as few as zero without impacting the layout of the page. This template will utilize advertisements that are specifically managed in a campaign management software and with content store in an image management interface.

An alternate, second template could be similar in layout to the first template and additionally giving consideration to the content being displayed in the content area section and having the ability to match up advertisements based on keywords found in the content. In one embodiment, this template would not integrate directly with an advertisement management interface, but rather would be used in situations where a third party advertisement service is utilized (such as, for example, Hey Butler®, Groupon®, Ebates®, ValueClick® or the like).

As know to those skilled in the art, using information from a database, such as age, gender, classes taken, etc., to better target a specific advertisement to a defined demographic increases the value of each impression of that advertisement. Advertisements that contain serialized coupons or other tracking information used to redeem offers allow an advertiser to better refine the rubric used to target advertisements using closed loop feedback.

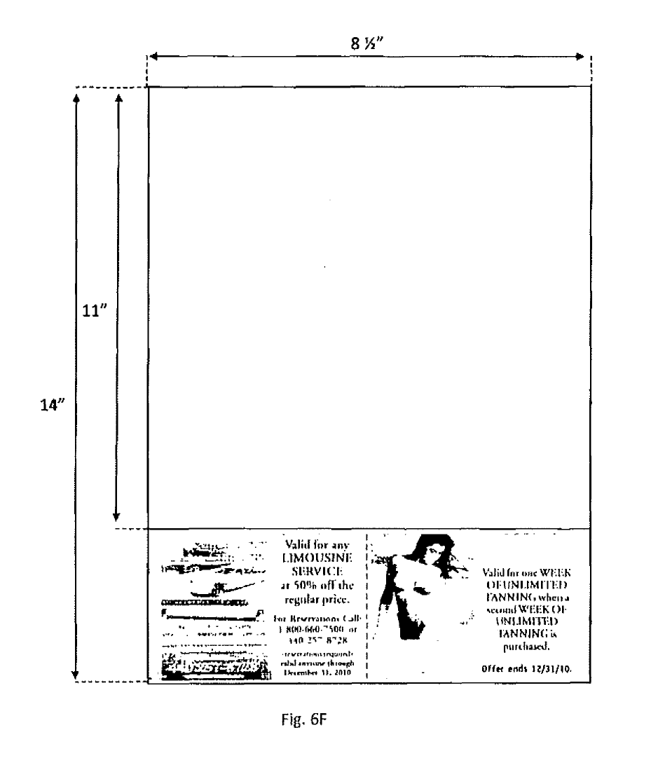

A computer network printing system also can be used to incorporate paid advertisements and other content into receipts that are printed in connection with point-of-sale and similar transactions, including receipts printed on roll or continuous-feed paper stock. As shown in FIG. 7, a computer network printing system can be implemented so that a print management module 700 captures a print request 720 for printing a receipt generated by a point-of-sale system 720 and generates a new print request 730 incorporating both the captured print request and advertisements or other additional content that is then sent to receipt printer 740. It should be understood that, in addition to dedicated point-of-sale terminals, point-of-sale system 720 includes additional embodiments. For example, in one embodiment point-of-sale system 720 may be a microcomputer that has, as one of its functionalities, the capability to act as a point-of-sale terminal.

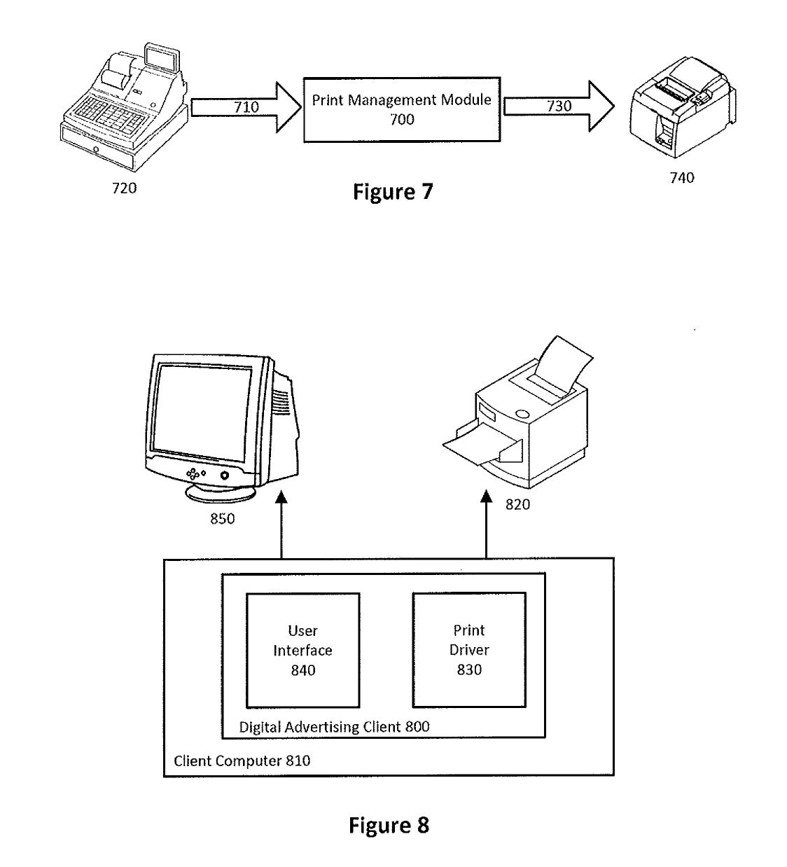

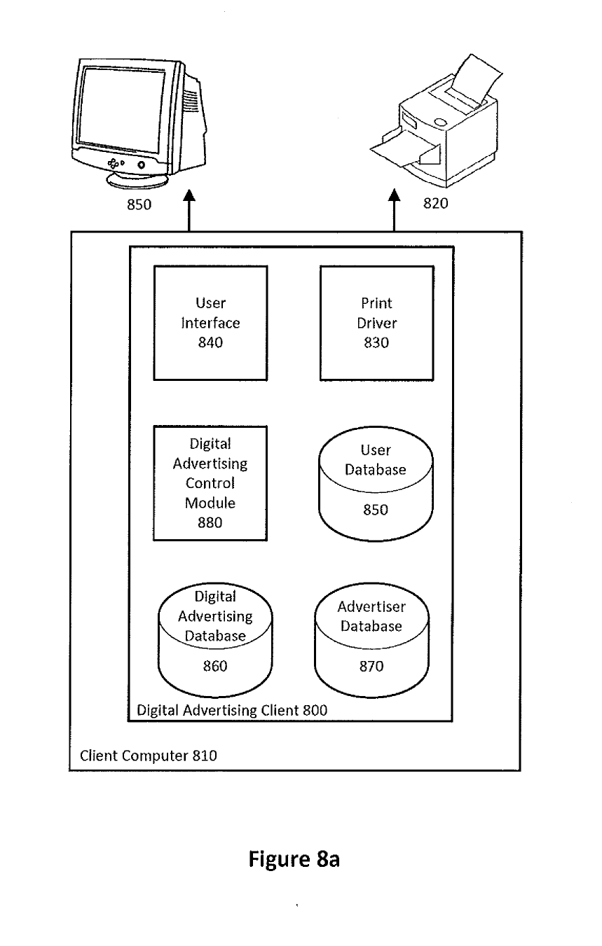

In one embodiment, new print request 730 is generated by inserting a print image compiled from captured print request 710 into a new print image according to a template with a first portion having one or more dimensions that correlate to dimensions specified by captured print request 710 and a second portion located outside of the first portion for insertion of advertisements or other content. Advertisements or other content is inserted into the second portion of new print request 730, and new print request 730 is directed to a printer to be printed on paper stock that is larger than one or more dimensions specified by captured print request 710 so as to accommodate both the content of captured print request 710 that has been inserted into the first portion and the advertisements that have been inserted into the second portion. In one embodiment, the larger paper stock can be dynamically sized based on one or more dimensions specified by new print request 730 using a roll or continuous-feed printer. It should be understood that print management module 700 may be implemented in the same manner as the print management module shown and described with respect to FIGS. 1 through 4. Print management module 700 also may include a print driver, an advertising control module, and user, advertising and advertiser databases of the type shown and described with respect to FIGS. 8 through 10, configured for use with printed advertisement and other printed content.

A computer network printing system also can be configured to present digital advertising to generate revenue and subsidize or offset printing costs. FIG. 8 illustrates an embodiment of a computer network printing system having a digital advertising client 800 for presenting a digital advertisement on monitor 850 connected to client computer 810 before the print request is printed using printer 820. It should be understood that client computer 810 may be any type of computer capable of generating a print request, including but not limited to point-of-sale system 720. As such, digital advertising client 800 may be used in addition or as an alternative to any other computer network printing systems, including those disclosed herein.

A digital advertisement may be targeted or un-targeted, and may comprise static content, video, audio, animation or any other media and content, including dynamic content, such as news feeds, social media feeds and other data streams. While a digital advertisement often will comprise promotional content, it also may comprise non-promoted informational content. In one embodiment, a digital advertisement could require user interaction before the print request is printed. Such interaction could include requiring user acknowledgement of the advertisement or more significant user interaction, such as responding to a survey or other engaging elements, and could result in an advertisement being incorporated into the print request, either as an additional page or consistent with the systems and methods disclosed herein. Interactions also could be used to generate and collect data regarding users of a network computer printing system that could be useful for targeting advertisements. For example, a survey could require a user to identify a major field of study, which information could then be used to target advertisements for job opportunities in that field. Data generated through such interactions may be associated with specific users or groups of users, may be combined with information from other data sources, and may be or stored in a data store within or independent of digital advertising client 800.

In one embodiment, digital advertising client 800 may reside entirely on the computer used to send a print request (i.e., client computer 810) and includes a printer driver 830 and a user interface 840. The user initiates a print request using client computer 810 by selecting the printer driver 830 in the same manner as an ordinary printer driver using the print dialog box. When the user generates a print request using printer driver 830, the print request is captured and user interface 840 is displayed to the user on monitor 850 connected to client computer 810. User interface 840 optionally may require the user to enter credentials associated with an account for tracking various metrics including print quotas, demographics and other relevant information. Digital advertising client 800 also can determine whether one or more digital advertisements should be displayed to the user and, if so, which ones. One or more digital advertisements can then displayed to the user on monitor 850, after which print request is directed to printer 820 to be printed.

As shown in FIG. 8a, an embodiment of digital advertising client 800 may include one or more databases, including user database 850 for storing and retrieving metrics including print quotas, demographics and other relevant information related to individual or groups of users, digital advertising database 860 for storing and retrieving digital advertisements, and advertiser database 870 for storing and retrieving information relating to the display of digital advertisements, it being understood that such databases may be implemented as a single database or multiple databases. Digital advertising client 800 also may include digital advertising control module 880 that interacts with one or more of print driver 830, user interface 840, user database 850, digital advertising database 860, and advertiser database 870. Digital advertising control module 880 may, for example, determine whether the user initiating a print request is within an established quota based on information stored in user database 850, determine which advertisements to present to a user based on information stored in user database 850 and advertiser database 870, retrieve advertisements to be presented to a user from digital advertising database 860, cause user interface 840 to present the digital advertisement on monitor 850, and debit an advertiser account stored in advertiser database 870. Digital advertising client 800 also may include functionality similar or analogous to the computer network printing system illustrated in and described with respect to FIGS. 1-4, including print queues, administrator interfaces, external institution account systems, import and export capabilities and the like.

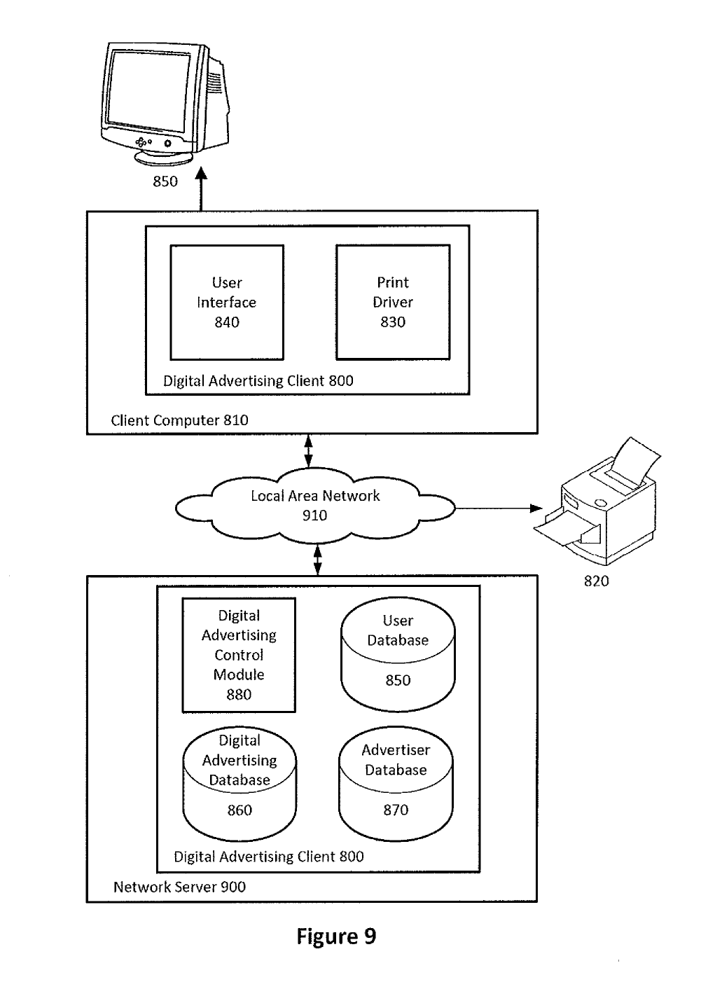

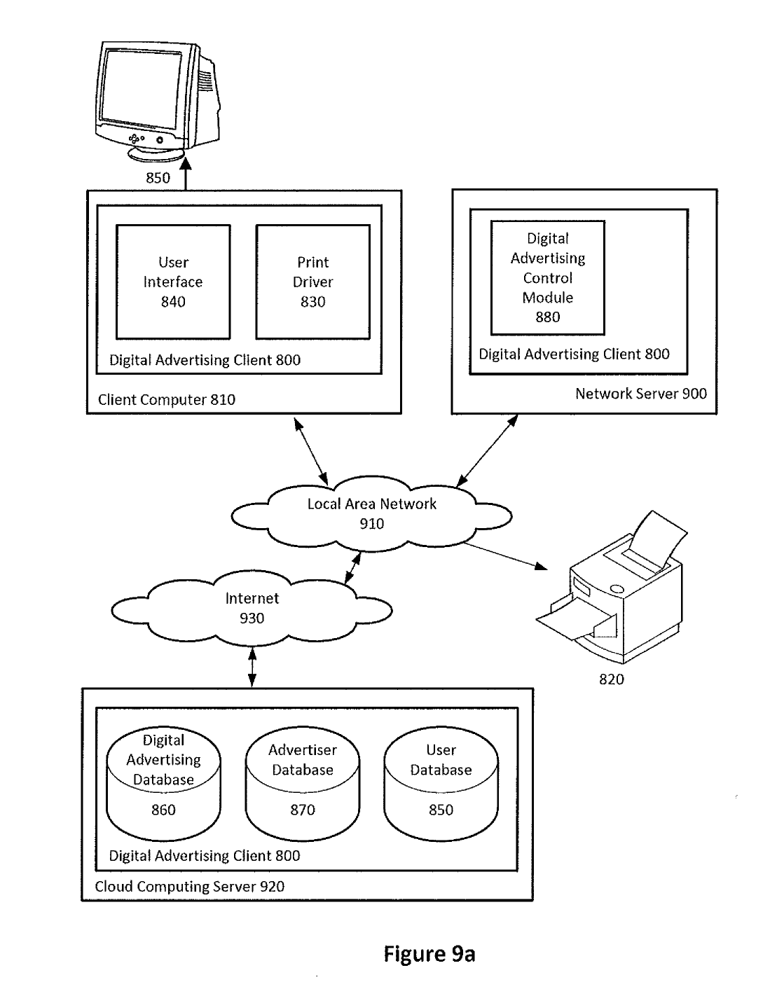

In many instances, printer driver 830 and user interface 840 will be implemented, at least in part, on client computer 810, as shown by way of example in FIG. 8. Elements of digital advertising client 800 also may be implemented on one or more networked servers. Client computer 810 and such servers may be connected using wired or wireless networking on a local area network or a wide-area network, including the internet. FIG. 9 illustrates an embodiment where digital advertising client 800 is implemented in part on client computer 810 and in part on network server 900, which is operatively connected to client computer 810 by local area network 910. In the illustrated embodiment, printer driver 830 and user interface 840 are implemented on client computer 810, and user database 850, digital advertising database 860, advertiser database 870 and digital advertising control module 880 are implemented on network server 900. Another embodiment is illustrated in FIG. 9a, where print driver 830 and user interface 840 are implemented on client computer 810, user database 850, digital advertising database 860 and advertiser database 870 are implemented on a cloud computing server 920, which is operatively connected to local area network 910 via internet 930, and digital control module 880 is implemented on local area network server 900, which is operably connected to local area network 910. Cloud computing server 920 may be implemented using a commercial cloud computing service, such as Amazon Web Services® or Google® Cloud Platform, a private cloud computing platform, or any other cloud computing platform. In another embodiment, digital advertising control module 880 could be implemented on cloud computing server 920 or another cloud computing service (not shown).

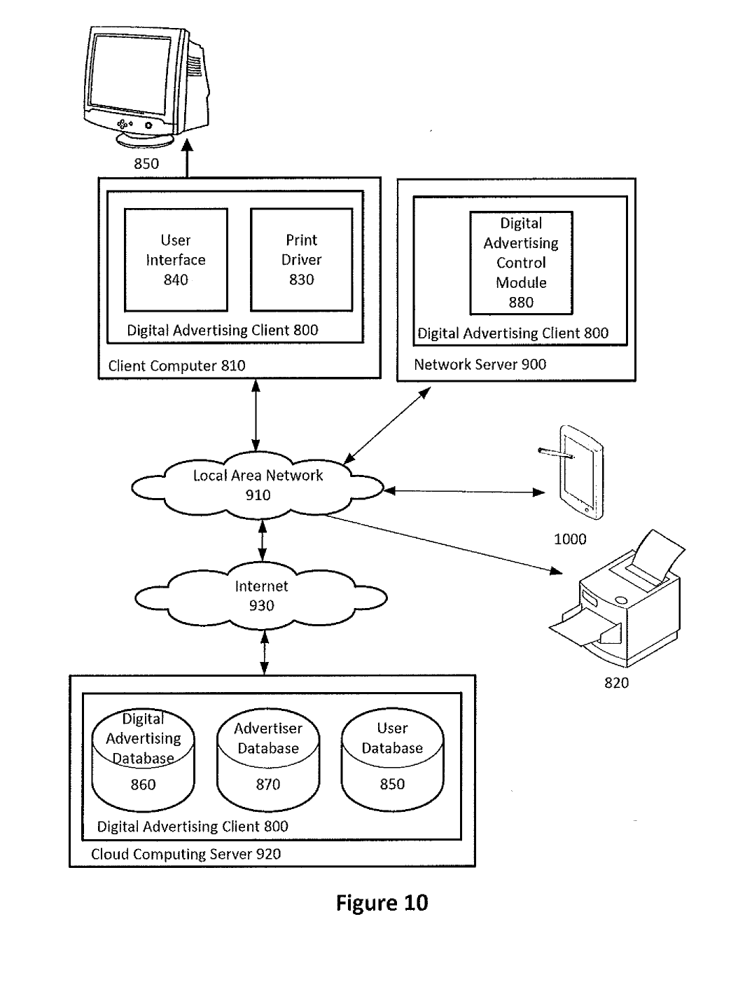

In addition, or as an alternative, to displaying digital advertisements on the computer used to initiate a print request, digital advertisements may be presented on a screen or any other device capable of displaying digital advertising besides client computer 810. In one embodiment, illustrated in FIG. 10, digital advertising client 800 is configured to display digital advertisements on interactive touch screen 1000 located in proximity to printer 820 before a print request is printed. So configured, digital advertising client 800 may function substantially in accordance with embodiments illustrated in FIGS. 8-9a and described above, except that, instead of presenting a digital advertisement on monitor 850, digital advertising client 800 causes a digital advertisement to be presented on interactive touch screen 1000, which can be operatively connected to local area network 910 using wired or wireless communications. A user optionally may be required to interact with a digital advertisement presented on interacting touch screen 1000 before the print request is printed.

In FIG. 10, display of a digital advertisement on interactive touch screen 1000 is initiated and controlled by digital advertising client 800 implemented on client computer 810. Alternatively, display of a digital advertisement can be initiated, controlled or both from networked servers such as, for example, network server 900, cloud computing server 920 or local area network server 900, shown in FIGS. 8 and 8a. Interactive touch screen 1000 also may be used for additional purposes, such as to release a particular print request to printer 820, to interact with network server 900 or cloud computing service 820, or for any other functionality that interactive touch screen 1000 may provide.

The foregoing descriptions of specific embodiments of a computer network printing system have been presented for purposes of illustration and description. They are not intended to be exhaustive or to limit the invention to the precise forms disclosed, and obviously many modifications and variations are possible in light of the above teaching. The embodiments were chosen and described to explain the principles of the invention and its practical applications, to thereby enable others skilled in the art to utilize the invention and various embodiments with various modifications as are suited to the particular use contemplated. It is intended that the scope of the invention be defined solely by the claims appended hereto, which are intended to include all modifications and alterations insofar as they come within the scope of the claims or the equivalents thereof.

1. A method, performed by a digital advertising client, for presenting a digital advertisement before a document is physically printed, comprising:
capturing a print request generated by a client computer;
selecting, automatically by the digital advertising client, a digital advertisement;
presenting, automatically by the digital advertising client, the selected digital advertisement; and
directing, automatically by the digital advertising client, the print request to a printer for printing after the selected digital advertisement has been presented.

2. The method of claim 1, wherein the digital advertising client is implemented on the client computer.

3. The method of claim 1, wherein the digital advertising client is implemented, at least in part, on a networked server or a cloud computing server.

4. The method of claim 1, wherein a digital advertisement is presented using a monitor operatively connected to the client computer.

5. The method of claim 1, wherein a digital advertisement is presented using a display device proximate to the printer to which the print request is directed.

6. The method of claim 1, wherein interaction with a digital advertisement is required before the print request is directed to a printer for printing.

7. The method of claim 1, wherein an advertisement is incorporated within the physically printed document.

8. The method of claim 7, wherein the client computer is a point-of-sale system.

9. A computer network printing system for presenting a digital advertisement before a document is physically printed, comprising:
a client computer for generating a print request
a digital advertising client for capturing a print request generated by a client computer, and further for presenting the selected digital advertisement before directing the captured print request to a printer for printing; and
a printer for physically printing the captured print request after a digital advertisement has been presented.

10. The computer network printing system of claim 9, wherein the digital advertising client comprises at least one of a user interface, a print driver, a digital advertising control module, a digital advertising database, an advertiser database or a user database.

11. The computer network printing system of claim 9, wherein the digital advertising client is implemented on the client computer.

12. The computer network printing system of claim 9, wherein the digital advertising client is implemented, at least in part, on a networked server or a cloud computing server.

13. The computer network printing system of claim 12, wherein the digital advertising client presents a digital advertisement using a monitor operatively connected to the client computer.

14. The computer network printing system of claim 12, wherein the digital advertising client presents a digital advertisement using a display device proximate to the printer to which the print request is directed.

15. The computer network printing system of claim 12, wherein the digital advertising client requires interaction with a digital advertisement before directing the print request to a printer for printing.

16. The computer network printing system of claim 13, further comprising a print management module for incorporating one or more advertisements within the physically printed document.

17. The computer network printing system of claim 16, wherein the client computer is a point-of-sale system.

18. A non-transitory computer-readable medium comprising executable instructions for:
capturing a print request generated by a client computer;
selecting, automatically by the digital advertising client, a digital advertisement;
presenting, automatically by the digital advertising client, the selected digital advertisement; and
directing, automatically by the digital advertising client, the print request to a printer for printing after the selected digital advertisement has been presented.

19. The non-transitory computer-readable medium comprising executable instructions of claim 18, further comprising executable instructions for a user interface, a print driver, a digital advertising control module, a digital advertising database, an advertiser database or a user database.

20. The non-transitory computer-readable medium comprising executable instructions of claim 18, further comprising executable instructions requiring interaction with a digital advertisement before directing the print request to a printer for printing.
